(19) United States
(12) Patent Application Publication
(10) Pub. No.: US 2015/0369968 A1
(43) Pub. Date: Dec. 24, 2015

(54) PROTECTIVE FILM MATERIAL, DISPLAY SUBSTRATE AND METHOD FOR PREPARING THE SAME

(71) Applicants: BOE TECHNOLOGY GROUP CO., LTD., BEIJING (CN); BEIJING BOE DISPLAY TECHNOLOGY CO., LTD., BEIJING (CN)

(72) Inventor: XIAOPENG CUI, BEIJING (CN)

(73) Assignees: BOE TECHNOLOGY GROUP CO., LTD., BEIJING (CN); BEIJING BOE DISPLAY TECHNOLOGY CO., LTD., BEIJING (CN)

(21) Appl. No.: 14/498,464

(22) Filed: Sep. 26, 2014

(30) Foreign Application Priority Data
Jun. 20, 2014 (CN) 201410280171.4

(51) Int. Cl. G02B 1/14; B05D 3/00; B05D 3/02; G02B 1/04; B05D 3/06

(52) U.S. Cl. CPC G02B 1/14; G02B 1/04; B05D 3/067; B05D 3/0272; B05D 3/002

(57) ABSTRACT

The invention discloses a protective film material, a display substrate and a method for preparing the same, and a display panel. The protective film material comprises: a protective film base, an ultraviolet absorbing pigment with a mass percent of 0.05-30% that is added to the protective film base, and an ultraviolet initiator with a mass percent of 0.05-10%, wherein the protective film base comprises a polymerizable monomer and a crosslinking agent. Because the molecules of the ultraviolet absorbing pigment and the ultraviolet initiator are small, they have a small influence on the flowability of a solution of the protective film base, so that the surface flatness of the protective film finally formed may be guaranteed. Moreover, adding the ultraviolet absorbing pigment causes a gradient change of the intensity of ultraviolet irradiation in the protective film, so that the surface of the protective film finally formed has a high tolerance.

### CROSS-REFERENCE TO RELATED APPLICATION

The present application claims priority to and incorporates by reference the entire contents of Chinese priority document 201410280171.4, filed in China on Jun. 20, 2014.

### TECHNICAL FIELD

The present invention relates to the field of liquid crystal display device manufacturing technologies, and in particular, to a protective film material, a display substrate and a method for preparing the same, and a display panel.

### BACKGROUND

During the manufacturing process of a display panel, it often appears that an element of the display panel is exposed to a harsh environment such as a solvent, an acid solution, an alkali solution and a high-temperature environment, etc. In order to prevent that the element is degraded or damaged in such a harsh environment, a protective film, which has a certain tolerance such as high temperature resistance and corrosion resistance, etc., is usually formed on the surface of the element to protect it. With the investment of high-generation production lines and the coming of the TFT-LCD flat panel display age, the manufacturing process of the display panel develops continuously, and the integration level of elements in the display panel becomes higher and higher; moreover, the critical dimension of each element is reduced continuously. Thus, in addition to the above tolerances, the protective film is also required to have a good flatness at the same time.

The existing protective film material is usually acrylate resin and epoxy resin, etc., with an acrylate crosslinking agent and an epoxy resin crosslinking agent, etc. In the prior art, when a protective film is prepared, it usually coats a solution of a protective film material on the surface of a base substrate, and then precures and bakes the solution in turn to make the molecules of the protective film material crosslinking polymerize with the crosslinking agent molecules so as to form a protective film.

However, during the preparation process of the existing protective film, in order to make the protective film have a good tolerance, it often requires that the protective film material have a high degree of polymerization and a large molecular weight; however, with the increasing of the degree of polymerization and the adding of the molecular weight, the flowability of the solution of the protective film material will be degraded, thus the surface flatness of the protective film prepared will be relatively poor. Therefore, it is difficult for the existing protective film to meet the double requirements of tolerance and flatness. As a result, it cannot meet the requirement laid by a high-quality refined display panel on the tolerance and flatness of the protective film.

### SUMMARY

It is an object of the invention to provide a protective film material, a display substrate and a method for preparing the same, and a display panel. A protective film prepared by the protective film material not only has a high tolerance, but also has a good flatness.

To attain the above object, the invention provides the technical solutions below:

In one embodiment, the invention provides a protective film material, comprising a protective film base, an ultraviolet absorbing pigment with a mass percent of 0.05-30%, and an ultraviolet initiator with a mass percent of 0.05-10%, wherein the protective film base comprises a polymerizable monomer and a crosslinking agent.

Because the molecules of the ultraviolet absorbing pigment and the ultraviolet initiator are small, when they are added to a solution of the protective film base, they have a small influence on the flowability of the solution of the protective film base, so that the surface flatness of a protective film formed by coating a homogeneously mixed solution of the protective film material on the surface of a display substrate may be guaranteed. Moreover, the adding of the ultraviolet absorbing pigment causes a gradient change along the ultraviolet irradiation direction from strong to weak of the intensity of ultraviolet irradiation that irradiates into the protective film, therefore, as initiated by the ultraviolet initiator, ultraviolet polymerization may occur on the polymerizable monomer molecules in the protective film on the side on which ultraviolet irradiation is strong, and crosslinking reaction may occur under crosslinking agent, so that the protective film has a high degree of polymerization and a large molecular weight on the side that is adjacent to the ultraviolet irradiation (i.e., adjacent to the surface of the protective film), thereby the surface of the protective film finally formed has a high tolerance.

In one example, the ultraviolet absorbing pigment is 2-(2′-hydroxyl-3′-tertiarybutyl-5′-methylphenyl)-5-chlorobenzotriazole; or

the ultraviolet absorbing pigment is 2-hydroxyl-4-n-octyloxybenzophenone; or

the ultraviolet absorbing pigment is bis{3-[3-(2-H-benzotriazole-2-yl)-4-hydroxyl-5-teriarybutylphenyl]-propanoic acid}-polyethyleneglycol300 ester.

In one example, the ultraviolet initiator is a carbonyl compound, a dye-type compound, an organic metal compound, a halogen-containing compound or a peroxy compound.

In one example, the ultraviolet initiator is: benzoyl peroxide, dilauroyl peroxide, azodiisobutyronitrile, diisopropyl peroxydicarbonate, dicyclohexylperoxy dicarbonate, benzophenone or benzoin dimethyl ether.

In one example, the polymerizable monomer are an acrylate monomer and a epoxy resin monomer.

In another embodiment, the invention further provides a display substrate, comprising a base substrate and a protective film which is formed on the base substrate and prepared by the protective film material provided in the above technical solution.

Because the protective film prepared by the above protective film material not only has a good flatness, but also has a high tolerance, in the display substrate according to the invention, the protective film on the surface of the display substrate has a good tolerance and a good surface flatness, thus it is favourable for increasing the tolerance and the surface flatness of the whole display substrate, thereby the product quality of the display substrate may be increased.

In one example, the thickness of the protective film is 0.5-20 μm.

Additionally, one embodiment of the invention further provides a method for preparing the display substrate according to the above technical solution, which comprises:

forming a protective film, wherein a layer of a solution of the protective film material is covered on the surface of a base substrate, and a protective film is formed via precure processing;

performing ultraviolet irradiation processing, wherein ultraviolet irradiation processing is performed on the protective film formed on the surface of a base substrate to cause the ultraviolet polymerization of the polymerizable monomer molecules on the surface of the protective film; and

performing heating processing, wherein heating processing is performed on the base substrate after ultraviolet irradiation processing to cause the thermal polymerization of the polymerizable monomer molecules inside the protective film so as to form a display substrate with a protective film on its surface.

Because in the protective material provided in the above technical solutions, the molecules of the ultraviolet absorbing pigment and the ultraviolet initiator are small, they have a small influence on the flowability of the solution of the protective film base, so that it may guarantee that the protective film formed by coating a solution of the protective film material on the surface of a base substrate can have a good surface flatness. Moreover, when ultraviolet irradiation processing is performed on the protective film formed on the surface of a base substrate, the ultraviolet absorbing pigment will absorb ultraviolet light and move to the side adjacent to ultraviolet irradiation, so that a gradient change from strong to weak will occur on the ultraviolet irradiation intensity in the protective film along a direction from the surface of the protective film to the base substrate, and the ultraviolet initiator and the crosslinking agent in the protective film will aggregate at a location with a high ultraviolet intensity, so as to under initiation of the ultraviolet initiator, the ultraviolet polymerization may occur on the polymerizable monomer molecules in the protective film on the side on which ultraviolet irradiation is strong, and crosslinking reaction may occur under crosslinking agent, thereby the surface of the protective film will have a high degree of polymerization and a large molecular weight, and the surface tolerance of the display substrate prepared by the preparation method according to the invention will be improved.

Thus, it may be known that the surface of the display substrate prepared by the method for preparing a display substrate according to the invention not only has a high tolerance, but also has a good flatness, and it can meet the manufacture requirements of a high-quality refined display panel produced on a high-generation production line.

In one example, the method further comprises cleaning and drying the base substrate before covering the layer of the solution of the protective film material on the surface of a base substrate.

In one example, the ultraviolet irradiation processing on the protective film formed on the surface of a base substrate comprises:

performing ultraviolet irradiation polymerization and crosslink on the protective film via an ultraviolet source at 1-100 cm above the surface of the protective film, wherein, the ultraviolet irradiation time is 1-60 mins, the ultraviolet wavelength is 365 nm, and the irradiation dosage is 0.001-100 mW/cm².

In one example, the heating processing on the base substrate after ultraviolet irradiation processing comprises:

placing the base substrate in a baking oven, heating up to 180-250° C. and keeping for 30-240 mins.

Additionally, another embodiment of the invention further provides a display panel, which comprises the display substrate provided in any of the above technical solutions.

Because the surface of the display substrate provided in the above technical solutions has a good tolerance and a good flatness, in the display panel according to the invention, the protective film on the surface of the display substrate has a good tolerance and a good flatness, thus it is favourable for improving the display effect and the product quality of the display panel of the invention.

### BRIEF DESCRIPTION OF THE DRAWINGS

FIG. 1 is a flow chart of a method for preparing a display substrate according to one embodiment of the invention;

FIG. 2 is a schematic diagram showing the distribution of molecules in the protective film formed after preparing in the method for preparing a display substrate according to one embodiment of the invention;

FIG. 3 is a schematic diagram showing the distribution of molecules in the protective film along a direction perpendicular to the base substrate after ultraviolet irradiation processing in the method for preparing a display substrate according to one embodiment of the invention;

FIG. 4 is a schematic diagram showing the distribution of molecules in the protective film along a direction perpendicular to the base substrate after heating processing in the method for preparing a display substrate according to one embodiment of the invention.

### LIST OF REFERENCE MARKS

10: Crosslinking Agent Molecules
20: Ultraviolet Absorbing Pigment Molecules
30: Polymerizable Monomer Molecules
40: Ultraviolet Initiator Molecules
P: Ultraviolet Irradiation Direction

### DETAILED DESCRIPTION

The technical solutions in the embodiments of the invention will be described clearly and fully below in conjunction with the drawings in the embodiments of the invention. Apparently, the embodiments described are only a part of the embodiments of the invention, rather than being the whole embodiments. All other embodiments made by one of ordinary skills in the art based on the embodiments of the invention without creative work pertain to the protection scope of the invention.

### Embodiment 1

The embodiment provides a protective film material, which comprises a protective film base, an ultraviolet absorbing pigment with a mass percent of 0.05-30% that is added to the protective film base; and an ultraviolet initiator with a mass percent of 0.05-10%, wherein the protective film base comprises a polymerizable monomer and a crosslinking agent.

Because the molecules of the ultraviolet absorbing pigment and the ultraviolet initiator are small, when they are added to the protective film base solution, they have a small influence on the flowability of the solution of the protective film base, so that the surface flatness of a protective film formed by coating a homogeneously mixed solution of the protective film material on the surface of a display substrate may be guaranteed. Moreover, the adding of the ultraviolet absorbing pigment causes a gradient change along the ultraviolet irradiation direction from strong to weak of the intensity of ultraviolet irradiation that irradiates into the protective film, therefore, as initiated by the ultraviolet initiator, ultraviolet polymerization may occur on the polymerizable monomer molecules in the protective film on the side on which ultraviolet irradiation is strong, and crosslinking reaction may occur under crosslinking agent, so that the protective film has a high degree of polymerization and a large molecular weight on the side that is adjacent to the ultraviolet irradiation (i.e., adjacent to the surface of the protective film), thereby the surface of the protective film finally formed has a high tolerance.

Therefore, the protective film prepared by the protective film material according to one embodiment of the invention not only has a good surface flatness, but also has a high tolerance.

Specifically, the above protective film base may employ a copolymer material made of a light-polymerizable monomer and a heat-polymerizable monomer, wherein the mass ratio of the light-polymerizable monomer to the heat-polymerizable monomer is 1:1, and the light-polymerizable monomer and the heat-polymerizable monomer are bonded. For example, the above protective film base may employ a copolymer material made of acrylate and epoxy resin, wherein the crosslinking agent contained in the above protective film base are an acrylate crosslinking agent and an epoxy resin crosslinking agent.

Preferably, the mass percent of the above ultraviolet absorbing pigment may be 1%-10%, specifically, it may be 1%, 2%, 3%, 5%, 8% and 10%; specifically, the mass percent of the above ultraviolet initiator may be 1%, 2%, 3%, 5%, 8% and 10%.

Optionally, the ultraviolet absorbing pigment may be the ultraviolet absorbent UV326, with a chemical name of: 2-(2′-hydroxyl-3′-teriarybutyl-5′-methylphenyl)-5-chlorobenzotriazole; or, the ultraviolet absorbing pigment may be the ultraviolet absorbent UV531, with a chemical name of 2-hydroxyl-4-n-octyloxybenzophenone; or, the ultraviolet absorbing pigment may be the ultraviolet absorbent Tinuvin1130, with a chemical name of: bis{3-[3-(2-H-benzotriazole-2-yl)-4-hydroxyl-5-teriarybutylphenyl]-propanoic acid}-polyethyleneglycol300 ester. However, the ultraviolet absorbing pigment may also be other compounds known in the prior art that have an ultraviolet absorbing function.

Optionally, the ultraviolet initiator may be a carbonyl compound, a dye-type compound, an organic metal compound, a halogen-containing compound or a peroxy compound, etc.; specifically, it may be benzoyl peroxide, dilauroyl peroxide, azodiisobutyronitrile, diisopropyl peroxydicarbonate, dicyclohexylperoxy dicarbonate, benzophenone or benzoin dimethyl ether.

### Embodiment 2

Embodiment 2 of the invention provides a display substrate, which comprises a base substrate and a protective film formed on the base substrate, wherein the protective film is prepared by the protective film material according to the above embodiment 1.

Because the protective film prepared by the protective film material according to the above Embodiment 1 not only has a good flatness, but also has a high tolerance. Thus, in the display substrate according to one embodiment of the invention, the protective film on the surface of the display substrate has a good tolerance and a good surface flatness, so that it is favourable for increasing the tolerance and surface flatness of the whole display substrate.

Preferably, the thickness of the protective film formed by coating a solution of the protective film material on the surface of a base substrate is 0.5-20 μm; more preferably, the thickness of the protective film may be 1-10 specifically, it may be 1 μm, 1.5 μm, 3 μm, 5 μm and 10 μm. Therefore, it may guarantee that the surface of the protective film after ultraviolet irradiation processing has a high degree of polymerization and a high molecular weight, thus the tolerance of the protective film prepared is improved, and at the same time it is favourable for the thinning of the display panel. However, the thickness of the protective film may also be set according to practical situations such as the type and size of the base substrate and the size of the workpiece on the base substrate, etc., and it will not be further described in detail here.

Preferably, the base substrate is an array substrate or a color filter substrate. The protective film is set on the surface of a thin-film transistor in the array substrate or on the surface of a color filter layer in the color filter substrate, so as to protect the thin-film transistor or the color filter layer.

### Embodiment 3

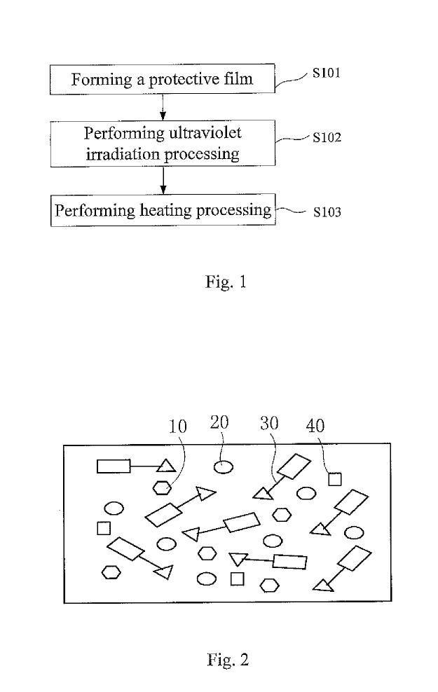

Referring to FIG. 1, Embodiment 3 of the invention provides a method for preparing the display substrate according to the above Embodiment 2, which comprises:

Step S101: forming a protective film, wherein a layer of a solution of the protective film material according to the above Embodiment 1 is covered on the surface of a base substrate, and precure processing is performed to form a protective film;

Step S102: performing ultraviolet irradiation processing, wherein ultraviolet irradiation processing is performed on the protective film formed on the surface of a base substrate to cause the ultraviolet polymerization of the polymerizable monomer molecules on the surface of the protective film; and

Step S103: performing heating processing, wherein heating processing is performed on the base substrate after ultraviolet irradiation processing to cause the thermal polymerization of the polymerizable monomer molecules inside the protective film, so as to form a display substrate with a protective film on its surface.

When a display substrate is prepared by the preparation method according to the embodiment of the invention, a solution of the protective film material according to the above Embodiment 1 is employed, and because the solution of the protective film material according to the above Embodiment 1 has a good flowability, it may guarantee that the protective film formed by coating a solution of the protective film material on the surface of a base substrate can have a good surface flatness.

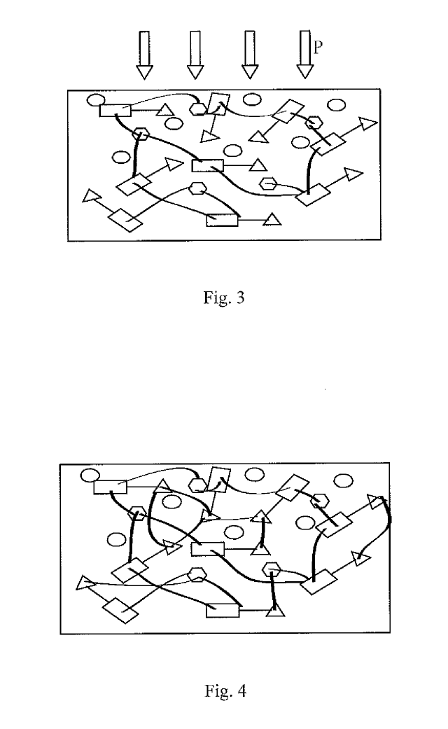

Moreover, when ultraviolet irradiation processing is performed on the protective film formed on the surface of a base substrate, the ultraviolet absorbing pigment molecules 20 will absorb ultraviolet light and move to the side adjacent to ultraviolet irradiation, that is, the ultraviolet absorbing pigment molecules 20 will move to the surface of the protective film, as shown in FIG. 2 and FIG. 3, so that the ultraviolet absorbing pigment molecules in the protective film will be distributed nonhomogeneously; as a result, the nearer to the surface of the protective film the ultraviolet absorbing pigment molecules in the protective film are, the higher the concentration thereof will be; and the nearer to the base substrate the ultraviolet absorbing pigment molecules in the protective film are, the lower the concentration thereof will be. Thus, when ultraviolet irradiation processing is performed, a gradient change from strong to weak will occur on the ultraviolet irradiation intensity in the protective film along the ultraviolet irradiation direction P. Moreover, the crosslinking agent molecules 10 in the protective film such as the acrylate crosslinking agent and the epoxy resin crosslinking agent, etc., also aggregate at a location with a high ultraviolet intensity, so that ultraviolet polymerization occurs on more polymerizable monomer molecules 30 at a location adjacent to the surface of the protective film, thereby the surface of the protective film will have a high degree of polymerization and a large molecular weight, and it may guarantee that the surface of the protective film formed has a high tolerance. As shown in FIG. 4, heating processing is then performed, and the epoxy resin crosslinking agent molecules 10 inside the protective film will again crosslinking polymerize with the polymerizable monomer molecules so as to form a display substrate with a protective film on its surface.

Thus, it may be known that the surface of the display substrate prepared by the method for preparing a display substrate according to the invention has a good flatness and a high tolerance.

Preferably, in the method for preparing a display substrate according to this embodiment, before forming a protective film on the surface of a base substrate, it may first clean and dry the base substrate to guarantee a clean base substrate, thus it may be avoided that the dust on the surface of a base substrate is wrapped in the protective film material, which will influence the light transmission effect of the protective film or the surface flatness of the protective film.

Optionally, in the above Step S101, when covering a solution of the protective film material on the surface of the base substrate, the solution of the protective film material may be coated on the substrate surface via a coating method such as spray coating, roller coating, spin coating or ink jetting, etc. However, other coating methods known in the prior art may also be employed, and it will not be further described in detail here.

Preferably, in the above Step S102, the ultraviolet irradiation processing on the protective film formed on the surface of a base substrate specifically comprises:

performing ultraviolet irradiation polymerization and crosslink on the protective film via an ultraviolet source at 1-100 cm above the surface of the protective film, wherein, the ultraviolet irradiation time is 1-60 mins, the ultraviolet wavelength is 365 nm, and the radiation dose is 0.001-100 mW/cm².

More specifically, in the above Step S102, the ultraviolet irradiation processing on the protective film formed on the surface of a base substrate specifically comprises:

performing ultraviolet irradiation polymerization and crosslink on the protective film via an ultraviolet source at 30 cm above the surface of the protective film, wherein, the ultraviolet irradiation time is 5 mins, the ultraviolet wavelength is 365 nm, and the radiation dose is 30 mW/cm².

Preferably, in the above Step S103, the heating processing on the base substrate after ultraviolet irradiation processing specifically comprises:

placing the base substrate in a baking oven, heating up to 180-250° C. and keeping for 30-240 mins, so as to cause a full thermal polymerization reaction of the molecules inside the protective film.

Specifically, the above heating temperature may be 180° C., 200° C., 230° C. or 250° C.; specifically, the temperature keeping time may be 30 mins, 60 mins, 90 mins, 120 mins or 240 mins.

In order to make one skilled in the art further understand the method for preparing a display substrate according to the invention and the performance of the protective film on the surface of the display substrate prepared by the preparation method according to the invention, one specific embodiment is provided in the invention to further explain the above method for preparing the display substrate. Specifically, the method has the steps below:

Step 1: cleaning and drying the base substrate;

Step 2: preparing a solution of a protective film material that comprises acrylate and epoxy resin as polymerizable monomer, crosslinking agent, an ultraviolet absorbent Tinuvin1130 with a mass percent of 2% and a benzoin dimethyl ether with a mass percent of 2%;

Step 3: coating the solution of the protective film material on the surface of a base substrate via a slit coating process to form a protective film, wherein, the thickness of the protective film formed is 1.5 μm;

Step 4: performing ultraviolet irradiation polymerization and crosslink on the protective film via an ultraviolet source at 30 cm above the surface of the protective film, wherein, the ultraviolet irradiation time is 5 mins, the ultraviolet wavelength is 365 nm, and the radiation dose is 30 mW/cm².

Step 5: placing the base substrate after ultraviolet irradiation processing in a baking oven at a temperature of 230° C., and keeping for 30 mins to cause thermal crosslinking polymerization of the polymerizable monomer molecules inside the protective film on the surface of a base substrate, so as to form a display substrate with a protective film on its surface.

Step 6: testing the related performance of the protective film on the surface of the display substrate, which is prepared by the above preparation method, wherein, the test method and the test result are as follows:

a) The transparency of the protective film is characterized by measuring the transmittance at 400 nm via a spectrophotometer, and the practically measured transmittance of the protective film on the surface of the display substrate prepared in this embodiment is 99.4%, which indicates that the protective film on the surface of the display substrate prepared by the preparation method according to this embodiment has an excellent light transmittance;

b) The surface roughness of the protective film on the surface of the display substrate prepared by the preparation method according to this embodiment is measured by an atomic force microscope, and the practically measured the surface roughness of the protective film is 0.75 nm, which indicates that the protective film on the surface of the display substrate prepared by the preparation method according to this embodiment has a good flatness;

c) The surface hardness of the protective film on the surface of the display substrate prepared by the preparation method according to this embodiment is measured via a pencil durometer, and the practically measured the surface hardness of the protective film is 6H, which indicates that the protective film on the surface of the display substrate prepared by the preparation method according to this embodiment has a good surface hardness, and it has a good wear resistance;

d) The corrosion resistance of the protective film is characterized by testing the weight loss rate of the display substrate before and after soaking in a solution of N-methylpyrrolidone (NW). A display substrate with a protective film on its surface is placed in an NMP solution at 60° C. and kept for 10 mins, and the measured weight loss rate of the display substrate before and after soaking is 0.7%, which indicates that the protective film on the surface of the display substrate prepared by the preparation method according to this embodiment has a good corrosion resistance.

e) The heat resistance of the protective film is characterized by the rate of change of the film thickness before and after heat processing. A display substrate with a protective film on its surface is placed in a baking oven at a temperature of 230° C. and kept for 30 mins, and the measured rate of change of the film thickness of the protective film is only 0.8%, which indicates that the protective film on the surface of the display substrate prepared by the preparation method according to this embodiment has an excellent heat resistance.

In conclusion, the protective film on the surface of the display substrate prepared by the method for preparing a display substrate according to the invention not only has a good light transmittance and a good flatness, but also has a high wear resistance, a high corrosion resistance and a high heat resistance, etc.

### Embodiment 4

Embodiment 4 of the invention provides a display panel, which comprises the display substrate according to the above Embodiment 2.

Because the surface of the display substrate according to the above Embodiment 2 has a good tolerance and a good flatness, in the display panel according to Embodiment 4 of the invention, the protective film on the surface of the display substrate has a good tolerance and a good flatness, thus it is favourable for improving the display effect and the product quality of the display panel according to this embodiment.

The display panel according to this embodiment may be the display panel of any product that has a display function, for example, mobile phone, tablet computer, TV set, display, notebook computer, digital photo frame and navigator, etc.

Apparently, various modifications and variations may be made by one skilled in the art without departing from the spirit and scope of the invention. Thus, if these modifications and variations pertain to the scope of the claims and their equivalents, the invention intends to encompass these modifications and variations.

What is claimed is:

1. A protective film material, comprising a protective film base, an ultraviolet absorbing pigment with a mass percent of 0.05-30%, and an ultraviolet initiator with a mass percent of 0.05-10%, wherein, the protective film base comprises a polymerizable monomer and a crosslinking agent.

2. The protective film material according to claim 1, wherein, the ultraviolet absorbing pigment is 2-(2′-hydroxyl-3′-teriarybutyl-5′-methylphenyl)-5-chlorobenzotriazole; or
the ultraviolet absorbing pigment is 2-hydroxyl-4-n-octyloxybenzophenone; or
the ultraviolet absorbing pigment is bis{3-[3-(2-H-benzotriazole-2-yl)-4-hydroxyl-5-teriarybutylphenyl]-propanoic acid}-polyethyleneglycol300 ester.

3. The protective film material according to claim 1, wherein, the ultraviolet initiator is a carbonyl compound, a dye-type compound, an organic metal compound, a halogen-containing compound or a peroxy compound.

4. The protective film material according to claim 3, wherein, the ultraviolet initiator is benzoyl peroxide, dilauroyl peroxide, azodiisobutyronitrile, diisopropyl peroxydicarbonate, dicyclohexylperoxy dicarbonate, benzophenone or benzoin dimethyl ether.

5. The protective film material according to claim 1, wherein, the polymerizable monomer are an acrylate monomer and a epoxy resin monomer.

6. A display substrate, comprising a base substrate and a protective film which is formed on the base substrate and is made of the protective film material according to claim 1.

7. The display substrate according to claim 6, wherein, the ultraviolet absorbing pigment is 2-(2′-hydroxyl-3′-teriarybutyl-5′-methylphenyl)-5-chlorobenzotriazole; or
the ultraviolet absorbing pigment is 2-hydroxyl-4-n-octyloxybenzophenone; or
the ultraviolet absorbing pigment is his {3-[3-(2-H-benzotriazole-2-yl)-4-hydroxyl-5-teriarybutylphenyl]-propanoic acid}-polyethyleneglycol300 ester.

8. The display substrate according to claim 6, wherein, the ultraviolet initiator is benzoyl peroxide, dilauroyl peroxide, azodiisobutyronitrile, diisopropyl peroxydicarbonate, dicyclohexylperoxy dicarbonate, benzophenone or benzoin dimethyl ether.

9. The display substrate according to claim 6, wherein, the thickness of the protective film is 0.5-20 μm.

10. A method for preparing the display substrate according to claim 6, comprising:
forming a protective film, wherein a layer of a solution of the protective film material is covered on the surface of a base substrate, and precure processing is performed to form a protective film;
performing ultraviolet irradiation processing, wherein ultraviolet irradiation processing is performed on the protective film to cause the ultraviolet polymerization of the polymerizable monomer molecules on the surface of the protective film; and
performing heating processing, wherein heating processing is performed on the base substrate after ultraviolet irradiation processing to cause the thermal polymerization of the polymerizable monomer molecules inside the protective film, so as to form a display substrate with a protective film on its surface.

11. The method according to claim 10, wherein, the thickness of the protective film is 0.5-20 μm.

12. The method according to claim 10, wherein, the method further comprises cleaning and drying the base substrate before covering the layer of the solution of the protective film material on the surface of a base substrate.

13. The method according to claim 10, wherein, the ultraviolet irradiation processing on the protective film comprises:
performing ultraviolet irradiation polymerization and crosslink on the protective film via an ultraviolet source at 1-100 cm above the surface of the protective film, wherein, the ultraviolet irradiation time is 1-60 mins, the ultraviolet wavelength is 365 nm, and the irradiation dosage is 0.001-100 mW/cm².

14. The method according to claim 10, wherein, the heating processing on the base substrate after ultraviolet irradiation processing comprises:
placing the base substrate in a baking oven, heating up to 180-250° C. and keeping for 30-240 mins.
